(19) United States
(12) Patent Application Publication
(10) Pub. No.: US 2026/0283109 A1
(43) Pub. Date: Sep. 24, 2026

(54) HOOF SPRAYING ARRANGEMENT, METHOD FOR THE CLEANING OF A HOOF AND USE THEREOF IN THE TREATMENT AND PREVENTION OF HOOF INFECTIONS IN ANIMALS

(71) Applicant: Intracare B.V., Veghel (NL)

(72) Inventor: Jan Van Geest, Veghel (NL)

(21) Appl. No.: 19/476,601

(22) PCT Filed: Apr. 17, 2024
(86) PCT No.: PCT/EP2024/060337

§ 371 Date: Oct. 17, 2025

(30) Foreign Application Priority Data
Apr. 18, 2023 (NL) 2034605

(51) Int. Cl. A01K 13/00; A01L 15/00; A61D 7/00; A61D 11/00

(52) U.S. Cl. CPC A01K 13/001; A01L 15/00; A61D 7/00; A61D 11/00

(57) ABSTRACT

Provided herein is a hoof spraying arrangement (10) to treat and/or prevent hoof infections in animals comprising at least one spraying device (18) for spraying at least one spraying substance (24) onto the one or more hooves (22), a control arrangement (100) to control the spraying of the spraying device (18), a detector arrangement (20) configured to determine the position of the hoof (22) in the hoof spraying arrangement (10), the detector arrangement (20) comprises at least one sensor (28), and at least one positioning arrangement (12) configured to position the spraying device (18) in a determined position relative to the detected position of the hoof (22). The detector arrangement (20) is physically connected to the positioning arrangement (12) to move simultaneously with the spraying device (18). Provided herein is also a method for cleaning a hoof (22) in a hoof spraying arrangement (10) and the use of said hoof spraying arrangement (10) for the treatment and/or prevention of hoof infection.

### FIELD OF THE INVENTION

The present inventions relate to a hoof spraying arrangement, method for the cleaning of a hoof of an animal in such a hoof spraying arrangement and the use of the arrangement for the treatment and prevention of claw and/or hoof infections in animals.

### BACKGROUND OF THE INVENTION

Farm animals such as cattle are prone to infectious diseases of the claws and/or hooves, such as hoof rot (interdigital phlegmon), stable hoof rot (interdigital dermatitis), and Digital Dermatitis, also known as “Papillomatous digital dermatitis” (PDD) or foot rot. Hoof and claw ailments in milk cattle causes stress to the animals and may result in reduced milk production, reduced fertility, and increased risk of mastitis.

The infected animals are often separated away from the herd as soon as possible to prevent the infection from spreading. Current treatment consists of cleaning the foot thoroughly, clipping the hoof with subsequent treatment with an antimicrobial product and/or providing product on the affected claw. Infectious diseases of the hoof and claw can be prevented and treated by utilizing a foot bath or footwrap with zinc sulfate and copper sulfate, but also other germicides such as hydrogen peroxide, or even an antibiotic can be used.

It is common in dairy farming to use the so-called foot bath to prevent diseases. Such a foot bath is usually placed where the cows exit the dairy parlor so that each cow is forced to walk through the foot bath. The foot bath normally comprises disinfectant that is dissolved in the water. A disadvantage of such a foot bath is that the foot bath may get contaminated by manure dropping in the foot bath. Also, if the foot of the cow is muddy, this mud will get dissolved and left behind in the foot bath and therefore, the foot bath needs to be emptied and cleaned on a regular basis which is time consuming and expensive due to the fact that the water and disinfectant needs to be replaced. JP 2020065761 describes a disinfection apparatus for disinfecting the hooves of animals while spraying disinfectant onto the hooves. It describes a first spraying device having a floor body with a plurality of movable bodies. When an animal steps onto one of the movable bodies, the movable body is pushed downwards and an opening opens up through which disinfectant can be sprayed on the bottom of the hoof. When the hoof is removed from the movable body, the opening is closed off again, and the disinfectant can no longer be ejected from the opening. Such a movable body may be delicate and if damaged, the disinfectant will continuously flow out the opening.

JP 202265761 also envisages a second spraying device which works based on a mechanism which is different from the first spraying device. The second spraying device is installed on a side of the floor body and a sensor is mounted on an injection nozzle which can be positioned to ensure spraying of a hoof of an animal when present on the floor body. Spraying of the disinfectant on the side of the hoof occurs as soon as the sensor 31 detects the presence of the hoof and the spraying stops when the sensor 31 no longer detects the hoof.

The sensor of the second spraying device in JP 2020065761 thus operates as an on/off sensor: when a hoof is detected, the disinfectant is sprayed, regardless of the position of the spraying device relative to the hoof of the animal. By doing so, disinfectant will often be waisted, as most of the time it is not of interest to spray the entire hoof, but a specific area needs to be treated with a higher amount of disinfectant.

CN 214285301 describes a hoof injection device similar to the first device described in in JP 2020065761 having a sensor floor pad wherein a trigger induction area is formed by cut-outs in the floor pad which hold sensors making it possible to locate the position of the hoof. A first spraying assembly is arranged at a first front end of the floor pad, while a second spraying assembly is arranged on the opposite back end of the floor pad so as to face the trigger induction area of the floor pad. When an animal enters the hoof injection device and steps on the sensor floor pad, the hoof of the animal is guided to the cut outs, the hoof is detected by the corresponding sensor and steers the spraying assemblies to the detected position of the hooves which are then sprayed. The sensor in CN 214285301 are located only in specifically foreseen cut-outs. If an animal does not place its hoof correctly inside a cut-out, the hoof is not detected.

There is a continuous need for improved cleaning, prevention and treatments effective against hoof infections, in particular foot rot, stable foot rot, and PDD, that is affordable, that is convenient to apply and that requires little maintenance of the arrangement. One or more of these needs are met by the present invention.

### SUMMARY OF THE INVENTION

Present inventors have noted that dairy production, animal health and welfare could be improved if the hooves of animals are cleaned and treated regularly to prevent or treat illness of the hooves. Present inventors have also noted that prior art arrangements are typically inefficient, require high maintenance and waste a lot of cleaning and treatment product. The inventors have found that a more efficient and economic manner of cleaning and/or treating of hooves can be achieved by providing a novel arrangement in an efficient manner and which may be entirely automated.

Accordingly, a first aspect of the invention provides a hoof spraying arrangement arranged to spray a spraying substance, such as a spraying liquid or spraying powder, onto one or more hooves of an animal preferably while the animal is stationary in the hoof spraying arrangement. In particular embodiments, the hoof spraying arrangement comprising at least one spraying device for spraying at least one spraying substance onto the one or more hooves of an animal, a control arrangement to control the spraying of the at least one spraying device, at least one detector arrangement configured to determine the position of the at least one hoof of the animal in the hoof spraying arrangement. In particular embodiments, the at least one detector arrangement comprises at least one sensor, and at least one positioning arrangement configured to position the at least one spraying device in a determined position relative to the detected position of the at least one hoof; preferably, the at least one detector arrangement is physically connected to the at least one positioning arrangement to move simultaneously with the at least one spraying device. In particular embodiments, the hoof spraying arrangement comprises at least one spraying device for spraying at least one spraying substance onto the one or more hooves of an animal, a control arrangement to control the spraying of the at least one spraying device, at least one detector arrangement comprising at least one sensor, and at least one positioning arrangement; the at least one spraying device being physically connected to the at least one positioning arrangement as to guide the movement of the at least one spraying device, wherein the at least one detector arrangement is physically connected to the at least one positioning arrangement such that the at least one spraying device and the at least one detector arrangement are moved simultaneously by the at least one positioning arrangement, wherein the at least one detector arrangement is configured to determine the position of the at least one hoof of the animal in the hoof spraying arrangement, and directs movement of the at least one positioning arrangement and the at least one spraying device to a desired position in relation to the detected position of the at least one hoof determined by the at least one detector arrangement. By doing so, it is possible to more accurately detect the position of the hoof and it will be possible to simultaneously position the spraying device of the hoof spraying arrangement behind the hoof and in a location which needs spraying. As such, a more precise spraying of the hoof will be accomplished by scanning and determining the position of the hoof, thereby positioning the spraying device relative to the hoof before starting the spraying operation. Accordingly in particular embodiments the control arrangement activates the spraying device only when the positioning arrangement is in the desired position. In particular embodiments, the at least one detector arrangement is positioned horizontally offset from the at least one spraying device on the at least one positioning arrangement. Positioning the at least one detector arrangement horizontally offset or horizontally remote from the at least one spraying device, being shifted in at least a horizontal and optionally also in a vertical direction, has the advantage that the detector arrangement can be used to identify the outer contour of the hoof of the animal while the spraying device is already positioned such that it is directed at the intended location for spraying. When the outer contour of the hoof is identified and the detector arrangement is aligned with this outer contour, the spraying device, being positioned horizontally and optionally vertically offset or shifted from the detector arrangement, will be positioned approximately behind the center of the hoof which in fact needs spraying. By spraying more centrally, less spraying product will be wasted due to incorrect alignment with the hoof of the animal and the need to spray the entire hoof in order to make sure that the areas which in fact needs spraying, is eliminated. In a particular embodiment, the detector arrangement is positioned between 2 and 10 cm horizontally offset from the position of the spraying device, more particular between 4 and 8 cm horizontally offset from the position of the spraying device, more particular 6 cm horizontally offset from the position of the spraying device. In general, a hoof of an animal is between 10 and 14 cm wide. By positioning the detector arrangement e.g. 6 cm horizontally offset from the spraying device, the detector arrangement will then be able to detect the outer contour of a hoof and stop the movement of the positioning arrangement. By doing so, the spraying device will be positioned 6 cm offset from this outer contour of the hoof and thus approximately in the middle of the hoof of the animal, which is in fact the area which needs spraying.

In a particular embodiment, the at least one spraying device is installed on one side of the positioning arrangement and the detector arrangement is installed on a second, opposite side of the positioning arrangement both facing the same direction for scanning and spraying. Such a setup will provide a more stable arrangement, due to an even distribution of weight on the positioning arrangement. Although the most stable arrangement will be that the at least one spraying device and the at least one detector device are positioned on the same horizontal line on the positioning arrangement, it may be possible that the at least one spraying device and/or the at least one detector device are also offset or shifted in the vertical direction.

In particular embodiments, the hoof spraying arrangement comprising a first positioning arrangement having a first detector arrangement and a first spraying device, and a second positioning arrangement having a second detector arrangement and a second spraying device.

In specific embodiments, the first and second positioning arrangement is configured to position the first detector arrangement and the first spraying device, and respectively the second detector arrangement and the second spraying device simultaneously relative to a first, and respective second hoof. Such a duplication of the positioning arrangement has the advantage that the scanning of the left hoof and the right hoof of the animal can occur at the same time, rather than first scanning and spraying the left hoof, and then scanning and spraying the right hoof. Also, due to simultaneous spraying of both the left and right hooves, it is likely that the animal will not lift and reposition the hooves, thus eliminating the need to reposition the positioning arrangements to apply the second spraying substance.

In particular embodiments, the detector arrangement comprises two sensors, the first sensor being positioned on a first side of the positioning arrangement and the second sensor being positioned on a second, opposite side of the positioning arrangement, and wherein the spraying device is positioned in between the first and second sensors on the positioning arrangement. Using two sensors, one on the left side of the positioning arrangement and one on the right side of the positioning arrangement, so both facing the location where the hooves are to be expected whereby the sensors are remotely positioned relating to each other, has the benefit that in case one sensor becomes inoperative, the scanning of the position of the hooves can still continue.

The spraying arrangement of the device of the present invention typically comprises a nozzle to ensure the dispersal of the liquid or powder. The nature of the nozzle is not critical and can be selected depending on the spraying range required. In a particular embodiment, the at least one spraying device comprises at least two nozzles. The at least two nozzles may be positioned vertically above one another. In particular embodiments, the spraying range of the first nozzle is wider than the spraying range of the second nozzle. In alternative embodiments, the first and the second nozzle have the same spraying range. In further alternative embodiments, the spraying range of the first nozzle is narrower than the spraying range of the second nozzle. Although it is possible to use the same nozzle to apply different spraying substances, using two or more nozzles allows for a different application range of the different nozzles. For instance, when washing the hoof of the animal, it is advantageous to use a wider spraying range such that the hoof is cleaned as much as possible. When additionally, the second treatment or prevention spraying substance is applied, it is more economically to apply this in a more centralized zone of the hoof where it is likely to have an infection or one to occur in the future.

In particular embodiments, the hoof spraying arrangement further comprises a rail or an extendable arm on which the at least one positioning arrangement is installed, and wherein the at least one positioning arrangement comprises a bracket for mounting the at least one spraying device and the at least one detector arrangement on the at least one positioning arrangement, and a drive unit, e.g. an electric motor, to move the bracket on the rail or the extendable arm to position the bracket in relation to a hoof of an animal. By installing the at least one positioning arrangement on a rail or an extendable arm, it is possible to move the at least one positioning arrangement such that it can be positioned where the actual spraying and applying of the spraying substance needs to happen. Using a rail or an extendable arm provides for a robust solution which can be installed in stables, dairy parlors, automatic milking system (AMS) and the like. Further, it is possible to foresee a cover which is installed above the rail or the extendable arm and hoof spraying arrangement such that the hoof spraying arrangement is shielded from accidental stepping on the arrangement by the cow when the cow enters the hoof spraying arrangement. Alternatively, the control arrangement may position the at least one positioning arrangement to the outer sides of the hoof spraying arrangement between spraying cycles, such that it is positioned in such a way that the animal will not be able to damage the positioning arrangement, the spraying device and/or the detector arrangement when the animal is entering or exiting the hoof spraying arrangement.

The invention also provides a method for the cleaning of a hoof of animals in a hoof spraying arrangement. The method comprises the steps of: identifying the presence of an animal in the hoof spraying arrangement, scanning the position of at least one hoof, positioning the at least one spraying device relative to the detected position of the at least one hoof, spraying at least a first spraying substance onto approximately the center point of the at least one hoof and optionally spraying a second spraying substance onto approximately the center point of the at least one hoof. By scanning and determining the position of the hoof of the animal, making sure that the spraying device is correctly aligned with the area that needs spraying, and then starting the spraying process, the method according to the invention will ensure that a minimum amount of spraying product can be used without much waist. Preferrable, the step of identifying the presence of an animal in the hoof spraying arrangement is done by a separate sensor, which will detect the presence of the animal. Such a sensor may be a pressure sensor installed in the floor of the hoof spraying arrangement, a motion detection sensor positioned above the hoof spraying arrangement to detect when an animal is moving to and from the hoof spraying arrangement or even a contact sensor detecting when e.g. a door connected to the hoof spraying arrangement is opened and closed to allow an animal to enter the hoof spraying arrangement. Other sensor arrangements to detect the presence of an animal are further possible and well known in the state of the art. The steps of identifying the position of the at least one hoof and positioning the at least one spraying device relative to the detected position of the at least one hoof may be done simultaneously.

In a particular embodiment, before spraying the second spraying substance onto approximately the center point of the at least one hoof, the method comprises the steps of redefining the position of the at least one hoof. By repeating the scanning process and repositioning the spraying device if needed, the second spraying substance will be applied in the correct location, rather than being sprayed next to the intended area when the animal has repositioned its hoof between the two spraying cycles.

In particular embodiments, the step of scanning the position of the at least one hoof comprises identifying an outer contour of the hoof of an animal.

The invention also provides the use of a hoof spraying arrangement to treat and/or prevent hoof infection in animals.

### FIGURES

FIG. 1 illustrates a top view of a hoof spraying arrangement according to a first embodiment of the invention.

FIG. 2 illustrates a top view of a hoof spraying arrangement according to a second embodiment of the invention.

FIG. 3 illustrates a top view of a hoof spraying arrangement according to a third embodiment of the invention.

FIG. 4 illustrates a front view of the hoof spraying arrangement according to the third embodiment of the invention.

FIG. 5 illustrates a front view of an alternative spraying device of the hoof spraying arrangement according to any of the embodiments of the invention.

FIG. 6 illustrates a 3D view of the hoof spraying arrangement showing a rail and a positioning arrangement placed under a protective cover.

FIG. 7 illustrates a schematic overview of a control arrangement according to the invention.

FIG. 8 illustrates a top view of a hoof spraying arrangement according to an embodiment of the invention.

FIG. 9 illustrates the detection of the hoof by an ultrasonic sensor according to an embodiment of the invention.

### DETAILED DESCRIPTION OF THE INVENTION

Before the present arrangement, method and use of the invention are described, it is to be understood that this invention is not limited to particular arrangements, methods, uses or combinations described, since such arrangements, methods and uses and combinations may, of course, vary. It is also to be understood that the terminology used herein is not intended to be limiting, since the scope of the present invention will be limited only by the appended claims.

As used herein, the singular forms “a”, “an”, and “the” include both singular and plural referents unless the context clearly dictates otherwise.

The terms “comprising”, “comprises” and “comprised of” as used herein are synonymous with “including”, “includes” or “containing”, “contains”, and are inclusive or open-ended and do not exclude additional, non-recited members, elements or method steps. The terms also encompass “consisting of” and “consisting essentially of”, which enjoy well-established meanings in patent terminology.

The recitation of numerical ranges by endpoints includes all numbers and fractions subsumed within the respective ranges, as well as the recited endpoints.

The terms “about” or “approximately” as used herein when referring to a measurable value such as a parameter, an amount, a temporal duration, and the like, are meant to encompass variations of and from the specified value, such as variations of +/−10% or less, preferably +/−5% or less, more preferably +/−1% or less, and still more preferably +/−0.1% or less of and from the specified value, insofar such variations are appropriate to perform in the disclosed invention. It is to be understood that the value to which the modifier “about” refers is itself also specifically, and preferably, disclosed.

Whereas the terms “one or more” or “at least one”, such as one or more members or at least one member of a group of members, is clear per se, by means of further exemplification, the term encompasses inter alia a reference to any one of said members, or to any two or more of said members, such as, e.g., any ≥3, 24, 25, 26 or 27 etc. of said members, and up to all said members. In another example, “one or more” or “at least one” may refer to 1, 2, 3, 4, 5, 6, 7 or more.

The discussion of the background to the invention herein is included to explain the context of the invention. This is not to be taken as an admission that any of the material referred to was published, known, or part of the common general knowledge in any country as of the priority date of any of the claims. Throughout this disclosure, various publications, patents and published patent specifications are referenced by an identifying citation. All documents cited in the present specification are hereby incorporated by reference in their entirety. In particular, the teachings or sections of such documents herein specifically referred to are incorporated by reference.

Unless otherwise defined, all terms used in disclosing the invention, including technical and scientific terms, have the meaning as commonly understood by one of ordinary skill in the art to which this invention belongs. By means of further guidance, term definitions are included to better appreciate the teaching of the invention. When specific terms are defined in connection with a particular aspect of the invention or a particular embodiment of the invention, such connotation is meant to apply throughout this specification, i.e., also in the context of other aspects or embodiments of the invention, unless otherwise defined.

In the following passages, different aspects or embodiments of the invention are defined in more detail. Each aspect or embodiment so defined may be combined with any other aspect(s) or embodiment(s) unless clearly indicated to the contrary. In particular, any feature indicated as being preferred or advantageous may be combined with any other feature or features indicated as being preferred or advantageous.

Reference throughout this specification to “one embodiment”, “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention, and form different embodiments, as would be understood by those in the art. For example, in the appended claims, any of the claimed embodiments can be used in any combination.

Accordingly, an aspect of the invention provides for a spraying arrangement for an animal body part as described herein. The examples herein relate to a hoof spraying arrangement, but it will be understood that the invention is not limited by this particular use. Accordingly, the reference to a hoof spraying arrangement as used herein should be read as referring more generally on an arrangement for spraying an animal body part, more particularly an arrangement for spraying a body part of a cattle animal, particularly dairy cattle. It will be understood that for the detection in the spraying arrangement of the invention, the position of the legs and/or hooves of an animal are of particular interest. For this reason, the description herein will generally refer to a hoof spraying arrangement. Accordingly, the invention provides a hoof spraying arrangement arranged to spray a spraying substance, such as a spraying liquid or spraying powder, onto one or more hooves of an animal preferably while they are stationary in the hoof spraying arrangement. The (spraying) arrangement as described herein is typically fixed onto a wall of a barn or a side of a milking unit. The arrangement of the present invention is typically positioned such that the animal body part, such as a cow hoof, can be sprayed when the animal is positioned in (i.e. in front of the detector of) the spraying arrangement, more particularly when the hind legs (and/or hooves) are positioned in the spraying arrangement. The hoof spraying arrangement as envisaged herein comprises at least one spraying device for spraying at least one spraying substance onto the one or more hooves of an animal, a control arrangement to control the spraying of the at least one spraying device, at least one detector arrangement comprising at least one sensor, and at least one positioning arrangement, the at least one spraying device being physically connected to the at least one positioning arrangement as to move the at least one spraying device, wherein the at least one detector arrangement is physically connected to the at least one positioning arrangement such that the at least one spraying device and the at least one detector arrangement are moved simultaneously by the at least one positioning arrangement, wherein the at least one detector arrangement is configured to determine the position of the at least one hoof of the animal in the hoof spraying arrangement, and wherein the at least one positioning arrangement is configured to move the at least one spraying device to a position in relation to the detected position of the at least one hoof determined by the at least one detector arrangement. By doing so, it is possible to detect the position of the hoof and it will be possible to simultaneously position the hoof spraying arrangement behind the hoof at the correct location which needs spraying. As such, a more precise spraying of the hoof will be accomplished. The area of the spraying arrangement of the invention as envisaged herein encompasses both the elements as recited herein and the envisaged spraying pattern of the spraying device. Thus, reference to an animal present “in” the hoof spraying arrangement as described herein implies that the animal is positioned within the area of the spraying arrangement such that it can be detected by the sensor and is reached by the spraying pattern of the spraying device of the spraying arrangement.

In the hoof spraying arrangement, preferably, at least one detector arrangement is positioned offset from the at least one spraying device on the at least one positioning arrangement. This means that, the line corresponding to the direction of the sensor and the line corresponding to the direction of the spray of the spraying device do not coincide when projected on a horizontal plane. This is also referred to herein as the direction of the sensor and the direction of the spraying device having a “horizontal offset”. The at least one detector arrangement is thus positioned remote from the at least one spraying device, being horizontally shifted or positioned or both in a horizontal and vertical direction compared to each other. The detector arrangement according to the present invention typically comprises a sensor to allow detection of the presence of an animal part, such as the hoof in a specific position and to activate the spraying device accordingly. Different types of detector arrangements are envisaged. The position of the animal part can be measured physically (by the touching of a sensor wire), based on heat sensing or based on the transmission or reflection of sound or light waves. In particular embodiments, the detector arrangement also comprises a wave source (such as a source of ultrasound waves). In particular embodiments, the wave source may be positioned independently from the detector arrangement (for instance on an opposing side of the spraying arrangement in a stable or other set up), provided that it ensures that the wave emitted by the signal source can be detected by the eye of the sensor and that the presence of an object (such as the hoof of an animal) will impact said wave detection by the sensor. In preferred embodiments, the detector arrangement comprises both a wave source and the eye of the sensor combined. In particular embodiments the detector arrangement comprises an ultrasonic sensor comprising a transmitter and a receiver. The ultrasonic transmitter and receiver can be placed side-by-side as close together as possible or the sensor can be an ultrasonic transceivers where the transmitter and receiver functions are integrated into a single unit. Where the wave source generates an ultrasonic beam, the sensor will detect reflected waves if an object, such as the hoof of an animal, passes in front of the beam. The spraying device and more particularly the nozzle thereof can be positioned such that when the detector arrangement identifies the position of the hoof, the desired area of the hoof is sprayed. Thus ideally, the eye of the detector arrangement and the nozzle of the spraying device are positioned in a given position relative to each other. In particular embodiments, the signal is an ultrasonic beam and the presence of an animal part is detected by a change in the reflected waves. In particular embodiments, with the lateral movement of the detection unit in the arrangement of the invention, the ultrasonic beam is reflected when an object is present in front of the sensor eye. In particular embodiments, the detector detects the falling edge of the reflected waves, which gives a signal to activate the spraying unit. Preferably, the spraying unit is positioned such that it can spray the desired position of the object when the sensory eye detects the falling edge of the reflected waves.

The position of the detector arrangement (more particularly the sensor eye) relative to the spraying nozzle may vary depending on the animal part of interest to be sprayed, the size, the breed and/or the age of the animal. For instance, where the animal part of interest is a cattle hoof, the detector arrangement, preferably a sensor eye of a sensor (i.e. the direction of the sensor) of the detector arrangement and more particularly the relevant part thereof, may be positioned between 2 and 10 cm horizontally offset from the position of the spraying device (i.e. the direction of the spray of the spraying device), preferably the spraying nozzle of the spraying device, more particular it may be positioned between 4 and 8 cm horizontally offset from the position of the spraying device or spraying nozzle, or even more particular it may be positioned about 6 cm horizontally offset from the position of the spraying device or spraying nozzle. Where the sensor is an ultrasonic sensor, and the signal is generated by the falling edge of the detection signal, the relevant part of the detector arrangement may be the edge of the ultrasonic beam, more particularly the edge that last passes over the object to be detected (in the direction of detection). Where the direction of detection is from left to right, the left edge of the beam will determine the drop in reflection by the object. The horizontal offset between the position of the detector arrangement and the spraying device, preferably between the spraying nozzle of the spraying device and the sensor eye of the sensor, more particularly the center of the spray pattern and the relevant part of the sensor, can be chosen such that this horizontal offset substantially matches the distance between the outer contour of a hoof and the center point of the hoof, or such that the spray pattern provided by a nozzle of the spraying device is directed onto a desired position of the hoof as soon as the position of the hoof is detected by the sensor eye of the detector arrangement. With “offset”, a distance between the position of the detector arrangement and the spraying device is intended. Such an offset can be in one plane, e.g. a horizontal plane, or a combination of a horizontal and vertical plane or direction. In particular embodiment, the nozzle of the spray is positioned at an angle relative to the sensor arrangement, so as to allow spraying of the side of the hoof and/or to direct the spray to an area of the hoof positioned below the spray arrangement.

In particular embodiments, the position of the hoof is determined by the fact that the sensor, which is moved laterally, no longer detects the object (hoof) directly or indirectly (such as the reflection of waves thereon). This has the advantage that the detector arrangement can be used to identify the outer contour of the hoof of the animal. When the outer contour of the hoof is identified and the detector arrangement is aligned with this outer contour, the spraying device, being positioned horizontally offset from the detector arrangement, will automatically be positioned approximately behind the center or location of the hoof which needs spraying. By spraying more centrally, less spraying product will be wasted due to incorrect alignment with the hoof of the animal. In additional or alternative embodiments, the position of the hoof is determined by the fact that the sensor, when moved laterally, detects the object (such as a hoof) directly or indirectly. Both types of detection can be combined, for instance to allow a second spraying of the hoof while moving the spraying arrangement back to its original position.

In further embodiments, the spraying arrangement may comprise two detector arrangements, each positioned on an opposing side of the spraying device, such that the position of the hoof can be detected using either one sensor in each direction of movement or both sensors in both directions of movement of the spraying arrangement.

It is possible to have the at least one spraying device is installed on one side of the positioning arrangement and the detector arrangement is installed on a second side along the rails of the positioning arrangement of the hoof spraying arrangement both facing the same direction for scanning and spraying. Such a setup will provide a more stable arrangement, due to an even distribution of weight on the positioning arrangement. Although the most stable arrangement will be that the at least one spraying device and the at least one detector device are positioned on the same horizontal line on the positioning arrangement, it may be possible that the at least one spraying device and/or the at least one detector device are also offset or shifted in the vertical direction. Alternatively it is possible to have the at least one spraying device installed on one extendable arm of the positioning arrangement and the detector arrangement is installed on a second extendable arm of the positioning arrangement of the hoof spraying arrangement. Preferably however in the devices of the invention, the position of the spraying device is fixed relative to that of the detector arrangement, such that there is a direct link between detection and spraying (the same or a different animal part).

Further, it is possible for the hoof spraying arrangement to comprise a first positioning arrangement having a first detector arrangement and a first spraying device, and a second positioning arrangement having a second detector arrangement and a second spraying device. Further, the first and second positioning arrangement may be configured to position the first detector arrangement and the first spraying device, and respectively the second detector arrangement and the second spraying device simultaneously relative to a first, and respective second hoof. Such a duplication of the positioning arrangement has the advantage that, if the spraying arrangement is set up such that it faces the back or the front of the animals, the scanning of the left hoof and the right hoof of the animal can occur at the same time, rather than first scanning and spraying the left hoof, and then scanning and spraying the right hoof. Also, due to simultaneous spraying of both the left and right hooves, it is likely that the animal will not lift and reposition the hooves, thus eliminating the need to reposition the positioning arrangements to apply the second spraying substance.

The spraying arrangement may also be set up such that it faces the side of the animal. Movement of the spraying device alongside the animal may ensure spraying of the front and hind hooves and may allow spraying of the front of the hoof and the back of the hoof. In such arrangements, the position of the spraying device is adjusted to ensure spraying of the desired area when the hoof is detected. As detailed above, the detector arrangement of the hoof spraying arrangement may comprise two sensors, the first sensor being positioned on a first side of the positioning arrangement and the second sensor being positioned on a second, opposite side of the positioning arrangement, and wherein the spraying device is positioned in between the first and second sensors. Using two sensors, one on the left side of the positioning arrangement and one on the right side of the positioning arrangement, so both facing the location where the hooves are to be expected whereby the sensors are remotely positioned relating to each other, has the benefit that in case one sensor becomes inoperative, the scanning of the position of the hooves can still continue. In particular embodiments, when two sensors are used, the first sensor and the second sensor detect the contour of the animal body part by detecting a change in the signal when the positioning arrangement moves along the body part. A signal is sent to stop the movement of the positioning arrangement and the spraying is activated.

The spraying arrangement of the device of the present invention typically comprises a nozzle to ensure the dispersal of the liquid or powder. The nature of the nozzle may be selected depending on the spraying range required. In a particular embodiment, the at least one spraying device of the hoof spraying arrangement may comprise at least two nozzles. The two nozzles may be positioned vertically above one another. The spraying range of one nozzle may be wider than the spraying range of the other nozzle. In alternative embodiments, the first and the second nozzle have the same spraying range. In further alternative embodiments, the spraying range of the first nozzle is narrower than the spraying range of the second nozzle. Although it is possible to use the same nozzle to apply different spraying substances, using two or more nozzles allows for a different application range of the different nozzles. For instance, when washing the hoof of the animal, it is advantageous to use a wider spraying range such that the hoof is cleaned as much as possible. When additionally, the second treatment or prevention spraying substance is applied, it is more economically to apply this in a more centralized zone of the hoof where it is likely to have an infection or one to occur in the future.

The hoof spraying arrangement may further comprise a rail on which the at least one positioning arrangement is installed, and wherein the at least one positioning arrangement may comprise a bracket for mounting the at least one spraying device and the at least one detector arrangement, and/or a drive unit, e.g. a motor, to move the bracket on the rail to position the bracket in relation to a hoof of an animal. By installing the at least one positioning arrangement on a rail, it is possible to move the at least one positioning arrangement such that it can be positioned where the actual spraying and applying of the spraying substance needs to happen. Using a rail provides for a robust solution which can be installed in stables, dairy parlors, automatic milking system (AMS) and the like. Alternatively, the hoof spraying arrangement may further comprise a extendable arm on which the at least one positioning arrangement is installed, and wherein the at least one positioning arrangement may comprise a bracket for mounting the at least one spraying device and a drive unit, e.g. a motor, to move the extendable arm, and thereby the bracket, to position the bracket in relation to a hoof of an animal. In preferred embodiments, the positioning arrangement on the extendable arm also comprises the detector arrangement.

Further, it is possible to foresee a cover which is installed above the rail or the extendable arm, and hoof spraying arrangement such that the hoof spraying arrangement is shielded from accidental stepping on the arrangement by the cow when the cow enters the hoof spraying arrangement. Alternatively, the control arrangement may position the at least one positioning arrangement to the outer sides of the hoof spraying arrangement between spraying cycles, such that it is positioned in such a way that the animal will not be able to damage the positioning arrangement, the spraying device and/or the detector arrangement when the animal is entering or exiting the hoof spraying arrangement.

In a further related aspect of the invention provides a method for the cleaning and/or therapeutic or prophylactic treatment of an animal part in a spraying arrangement, preferably the spraying arrangement according to an embodiment described herein. In particular embodiments, the method may comprise the steps of: scanning the position of a part of the animal and spraying a spraying substance onto a desired position of the animal part, such as onto approximately the center point of the animal part. Optionally the method also comprises identifying the presence of an animal close to the spraying arrangement. Therefore, a sensor can be used which will detect the presence of the animal. Such a sensor may be a pressure sensor installed in the floor close to the spraying arrangement, a motion detection sensor positioned above the spraying arrangement to detect when an animal is moving to and from or in the vicinity of the spraying arrangement or even an contact sensor detecting when e.g. a door is used to separate the spraying arrangement from its surroundings which can then be opened and closed to allow an animal to enter the spraying arrangement. Other sensor arrangements to detect the presence of an animal are further possible and well known in the state of the art. In particular embodiments, the method comprises the step of positioning the at least one spraying device relative to the detected position of the animal part. The steps of identifying the position of the at least one hoof and positioning the at least one spraying device relative to the detected position of the at least one hoof may be done simultaneously. In particular embodiments of the methods of the invention, the spraying arrangement is configured to ensure that, upon scanning the position of said at least one hoof, a spraying arrangement is activated which is positioned to spray the desired area of the hoof. The methods may further comprise the use of the spraying arrangements described herein and may optionally comprise spraying the animal with two or more different substances. The nature of the substances may vary and can include cleaning, prophylactic and/or therapeutic substances. In particular embodiments, the methods further comprise spraying a second substance onto the center point of the animal part. In particular embodiments, the method may comprise simultaneously or sequentially spraying several parts of the animal.

In particular embodiments, the step of scanning the position of an animal body part comprises moving the detector arrangement so as to allow the detector to determine the position of the body part.

As an embodiment of the methods described above the invention provides a method for the cleaning and/or prophylactic or therapeutic treatment of a hoof of an animal in a hoof spraying arrangement, preferably the hoof spraying arrangement according to an embodiment described herein. In particular embodiments, the method may comprise the steps of:
scanning the position of at least one hoof; and
spraying a spraying substance onto approximately the center point of the hoof. In particular embodiments, the method comprises the step of positioning the at least one spraying device relative to the detected position of the at least one hoof. In particular embodiments of the methods of the invention, the spraying arrangement is configured to ensure that upon scanning the position of said at least one hoof, a spraying arrangement is activated which is positioned to spray the desired area of the hoof. In particular embodiments the method may comprise identifying the presence of an animal in the hoof spraying arrangement. In particular embodiments, the methods further comprise spraying a second substance onto the center point of the hoof. In particular embodiments, the method may comprise simultaneously or sequentially spraying several hooves of the animal. In particular embodiments, the step of scanning the position of the hoof comprises moving the detector arrangement laterally (horizontally) so as to allow the detector to determine the position of the hoof. In particular embodiments the actions involved in the use of the spraying arrangement when used in the context of the cleaning and/or cow hooves can be described as follows. When the cow is present, the drive unit which moves spraying arrangement in a given lateral direction (transversal to the leg of the cow) is started clockwise moving the spraying arrangement along while detecting the presence of the hoof. When the sensor detects that the end of the hoof is reached, e.g. by detecting the falling edge of the reflected waves, the motor is stopped and the spray is activated. In particular embodiments, the drive unit can move the spraying arrangement back to its original position after a first spraying and thereafter again start moving to detect the position of the hoof for a second spraying. Alternatively, the drive unit can move the spraying arrangement in the opposing direction and activate the second spray when the presence of the hoof is detected. In further embodiments, the care of the cow hoof is carried out in a milking system. The method of the invention may then be programmed so as to take into account the milk production and carry out the second spraying only after the milk production has stopped. This may allow the hoof to dry before the second spraying.

In particular embodiments, where the method comprises spraying a first and a second spraying substance, the methods may comprise, before spraying the second spraying substance onto approximately the center point of the at least one hoof, the step of redefining the position of the at least one hoof. In particular embodiments, where the spraying arrangement is not fixed to the detector arrangement, the method may comprise actively positioning the spraying device. Alternatively, where the spraying arrangement is fixed to the detector arrangement, the re-scanning or redefining will ensure that the spraying substance is sprayed onto the desired position of the hoof.

In a particular embodiment, the method for the cleaning of a hoof of animals in a hoof spraying arrangement is carried out in a milking system comprising said hoof spraying arrangement, preferably an automated milking system hoof spraying arrangement; wherein the method comprises the steps of:
a) providing the animal in the hoof spraying arrangement within the milking system;
b) identifying the presence of an animal in the hoof spraying arrangement;
c) scanning the position of at least one hoof thereby positioning the spraying arrangement in the desired position relative to the hoof
d) spraying at least a first spraying substance onto approximately the center point of the at least one hoof and/or spraying a second spraying substance onto approximately the center point of the at least one hoof;
e) milking the animal in the milking system; and,
f) optionally, steps a) to d) may be repeated after step e).

Such methods may lower the risk of contamination of the milk by dirt which may be present on the hooves of the animals upon entering the milking system.

The step of scanning the position of the at least one hoof may comprises identifying an outer contour of the hoof of an animal. The steps of scanning and positioning may be done simultaneously. hoof spraying arrangement may be used to treat or prevent hoof infection in animals.

### EXAMPLES

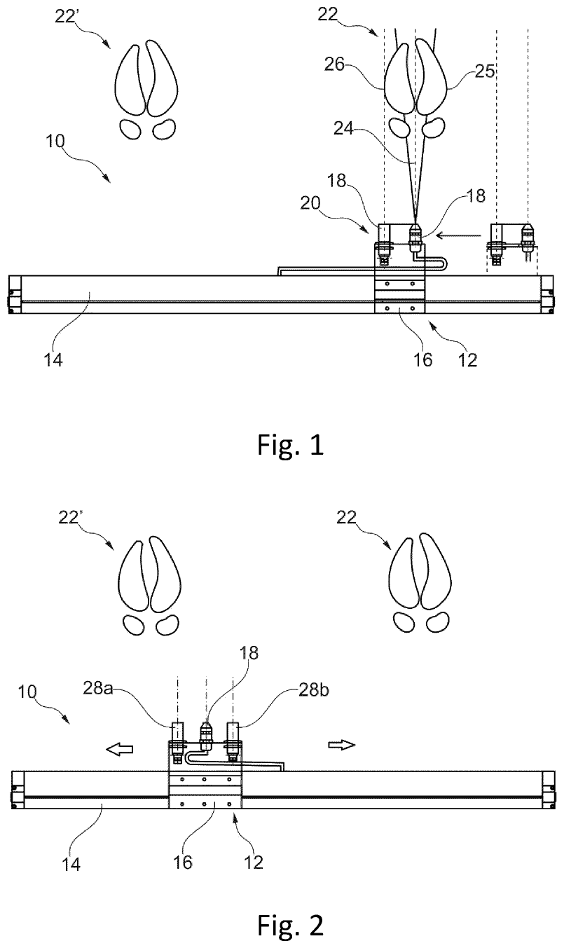

FIG. 1 shows a top view of a hoof spraying arrangement 10 according to a first embodiment of the invention. The hoof spraying arrangement comprises a positioning arrangement 12 having a bracket 16 installed on a rail 14 to allow movement of the bracket 16 across the rail 14 by a drive unit, e.g. a motor, (not shown). The drive unit 30 can be driven electrically, hydraulically, pneumatically, or in any other suitable manner and may be installed on the positioning arrangement 12 between the rail 14 and bracket 16.

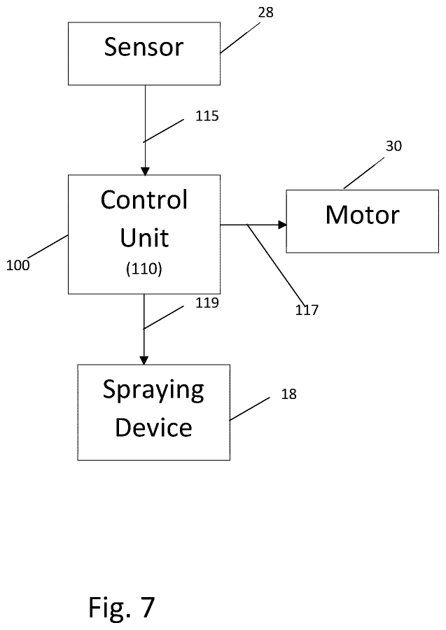

A spraying device 18 and a detector arrangement 20 are mounted on the bracket 16 for simultaneous movement with the bracket 16 on the rail 14. The detector arrangement 20 comprises at least one sensor 28 which will continuously scan for a position of the hoof 22 of the animal in the hoof spraying arrangement 10. When the bracket 16 is moved from a position to the right on the rail 14 to a position on the left, the sensor 28 will first detect the right outer contour 25 of the hoof 22 of the animal. Continued movement of the bracket 16 by the drive unit 30 will move the detector arrangement 20 comprising the sensor 28 along and beyond the hoof 22 of the animal. Once the sensor 28 no longer detects the presence of the hoof 22, a signal 115 (see FIG. 7) will be given by the sensor 28 to a control unit 110 of a control arrangement 100. Upon receipt of the signal 115 by the control unit 110, the control unit 110 will send a control signal 117 to the drive unit 30 which will then stop movement of the positioning arrangement 12. Subsequently, the control unit 110 will send a control spraying signal 119 to the spraying device 18 to apply a spraying substance such as a spraying liquid or a spraying powder 24 to the identified hoof 22 during a predetermined time. Optionally, the control unit 110 may send a control signal to the drive unit 30 such that the bracket 16 is slowly moved again to the right up to a point where the sensor 28 again detects the left outer contour 26 before the liquid 24 is applied by the spraying device 18. That way, the time needed for the bracket 16 to stop moving and possible misalignment of the bracket 16 is eliminated and the positioning arrangement 12 is correctly aligned with the left outer contour 26 of the hoof 22.

The movement of the bracket 16 across the rail 14 will thus allow for a correct alignment of the detector arrangement 20 to the left outer contour 26 of a first hoof 22 of the animal.

The detector arrangement 20 and spraying device 18 are mounted on the same bracket 16 in such a way that a predetermined distance is achieved between the position of the detector arrangement 20 comprising the at least one sensor 28 and the spraying device 18. The detector arrangement 20 is positioned between 2 and 10 cm horizontally offset from the position of the spraying device 18, more particular between 4 and 8 cm horizontally offset from the position of the spraying device 18, more particular 6 cm horizontally offset from the position of the spraying device 18. The detector arrangement 20 is thus positioned remote from the spraying device 18, being horizontally shifted or positioned or both in a horizontal and vertical direction compared to each other. These different positions between the detector arrangement 20 and the spraying device 18 may be measured between the sensor eye of the sensor 28 of the detector arrangement 20 and a spraying nozzle 32a, 32b, of the spraying device 18 such that a more accurate distance is accomplished. The horizontal offset between the position of the detector arrangement 20 and the spraying device 18, or thus between the sensor eye and the spraying nozzle, can be chosen such that this horizontal offset substantially matches the distance between the outer contour 25, 26 of a hoof 22 and the center point of the hoof 22, Alternatively, the position can be chosen such that the spay pattern provided by a nozzle 32a, 32b of the spraying device 18 is directed onto a desired position of the hoof 22 as soon as the hoof is detected by the sensor eye of the detector arrangement 20. The inventors have found that a hoof in general is between 10 and 14 cm in width. Thus, positioning the detector arrangement 20 and the spraying device 18 approximately 6 cm from each other will result in the spraying device 18 being pointed at the center point of the hoof 22 when the detector arrangement 20 is aligned with the outer contour 26 of the same hoof 22. Preferably, the at least one spraying device 18 is installed on one side of the bracket 16 of the positioning arrangement 12 and the detector arrangement 20 is installed on a second, opposite side of the bracket 16 of the positioning arrangement 12. Positioning the spraying device 18 and detector arrangement 20 on opposite sides of the bracket 16 will improve the stability of the bracket when mounted on the rail 14 and will allow for a smooth movement by the drive unit 30. Alternatively, the bracket 16 may be larger than needed according to the average width of a hoof, allowing more flexibility to reposition the spraying device 18 and/or the detector arrangement 20 on the bracket. As such, it is possible to change the preferred distance of e.g. 6 cm between the spraying device 18 and the detector arrangement 20 to e.g. 7 cm or 5 cm, depending on the particular needs of the farmer and/or depending on the actual size of the hoof, which may depend on breed and age of the cattle.

As can be seen from FIG. 1, the rail 14 is positioned such that it allows for the bracket 16 to move behind both the left hoof of the animal and the right hoof of the animal. Once the right hoof of the animal is detected and the spraying device 18 has applied the spraying liquid 24 to the right hoof 22 of the animal, the bracket 16 will be moved further to the left to allow the sensor 28 to identify the position of the left hoof 22′ of the animal.

Similar to the detection of the right hoof 22, the sensor 28 will first identify the right outer contour 25′ of the left hoof 22′. The bracket 16 will continue to be moved by the drive unit up to a point where the sensor 28 no longer detects the left hoof 22′. Once the sensor 28 has passed the left hoof 22′, it will again send a signal 115 to the control unit 110 which will then stop the drive unit 30 from moving the bracket 16 along the rail 14.

In order to spray and treat both the front legs and the hind legs of the animals when the animal is present in the hoof spraying arrangement 10 and without the need to reposition the animal in the hoof spraying arrangement, a duplication of the arrangement can be foreseen. Therefore, a similar set up comprising a rail 14, positioning arrangement 12, bracket 16, spraying device 18 and detector arrangement 20 is placed behind the front legs as to scan, detect and spray the front right hoof and subsequently scan, detect, and spray the front left hoof of the animal. The use of the front arrangement and the rear arrangement can occur at the same time, reducing the overall time needed to spray all four hooves of the animal when placed inside the hoof spraying arrangement 10. A duplication of the arrangement may also be foreseen facing the opposite direction of the first arrangement and positioned so it may also spray the front side of the hoof.

FIG. 2 shows a top view of a hoof spraying arrangement 10 according to a second embodiment of the present invention. The hoof spraying arrangement 10 of FIG. 2 also comprises the positioning arrangement 12 having a bracket 16 installed on the rail 14 to allow movement of the bracket 16 across the rail 14 by the drive unit 30. In the embodiment of FIG. 2, the detector arrangement 20 comprises two sensors 28 installed on the bracket 16 and at least one spraying device 18 positioned in between the two sensors on the bracket 16. When the bracket 16 is moved from one position to another position on the rail 14, both sensors 28a and 28b will continuously scan for a position of the hoof 22 of the animal in the hoof spraying arrangement 10. When the bracket 16 is positioned to the right on the bracket, a first sensor 28a will, similar to the embodiment of FIG. 1, first detect the right outer contour 25 of the hoof 22 of the animal. Continued movement of the bracket 16 by the drive unit 30 to the left will move the first sensor 28a along and beyond the hoof 22 of the animal. Once the sensor 28a no longer detects the presence of the hoof 22, a signal 115a will be given by the sensor 28a to the control unit 110 of the control arrangement 100. Upon receipt of the signal 115a by the control unit 110, the control unit 110 will send a control signal 117 to the drive unit 30 which will then stop movement of the positioning arrangement 12. Subsequently, the control unit 110 will send a control spraying signal 119 to the spraying device 18 to apply a liquid 24 to the identified hoof 22 during a predetermined time. During the movement of the positioning arrangement 12 along the rail 14, it is possible that the second sensor 28b will at one point also detect the right outer contour 25 of the hoof of the animal before detection of the left outer contour 26 of the hoof by the first sensor 28a. The second sensor 28b, upon detection of the right outer contour 25 of the hoof, is able to send a signal 115b to the control unit 110 which will, upon receipt of the signal 115b, send a control signal 117 to the drive unit to stop the movement of the positioning arrangement 12. Thus, although it is possible to only stop movement of the positioning arrangement 12 upon sending the signal 115a by the first sensor 28a, the movement of the positioning arrangement 12 can also be controlled by the presence of signal 115b by the second sensor 28b. Regardless of which sensor signal 115a or 115b is received and used by the control unit 110, the control unit 110 will send a control spraying signal 119 to the spraying device 18 upon receipt of the sensor signal 115a and/or 115b, to apply the liquid 24 to the identified hoof 22 during a predetermined time.

However, if the positioning arrangement 12 would be positioned on the lefthand side of the hoof spraying arrangement 10, and the positioning arrangement 12 would move from a left position to the right, the second sensor 28b will be the sensor which first detects the left outer contour 26 of the hoof of the animal, and will, as soon as it no longer detects the presence of the hoof 22, send a sensor signal 115b to the control unit 110 to stop movement of the positioning arrangement 12 and to send a spraying signal 119 to the spraying device 18 to apply a liquid to the detected hoof.

Alternatively, the control arrangement 100 is able to identify if the positioning arrangement 12 is moving from the left side of the hoof spraying arrangement 10 to the right side, or vice versa. Such movement may be detected by a direction sensor (not shown) and will allow the control unit 110 to identify which sensor signal 115a or 115b to use as input signal to control the movement of the drive unit 30.

Also, a combined use of both sensors 28a and 28b is possible in the embodiment of FIG. 2. If the positioning arrangement 12 is moving from right to left, the first sensor 28a will first detect the right outer contour 25 of the hoof. The positioning arrangement 12 continues its movement along the rail 14, and the control unit 110 will only stop the movement of the positioning arrangement 12 when the second sensor 28b also detects the right outer contour 25 of the hoof.

Additionally, using two sensors 28a and 28b has the advantage that the scanning of the hoof by the detector arrangement 12 of the hoof spraying arrangement 10 can be used starting from both sides of the hoof spraying arrangement 10.

Like in the embodiment of FIG. 1, the hoof spraying arrangement 10 of the embodiment as shown in FIG. 2 can likewise be duplicated in order to detect, spray and treat both the front legs and hind legs of the animal without the need to reposition the animal in the hoof spraying arrangement 10.

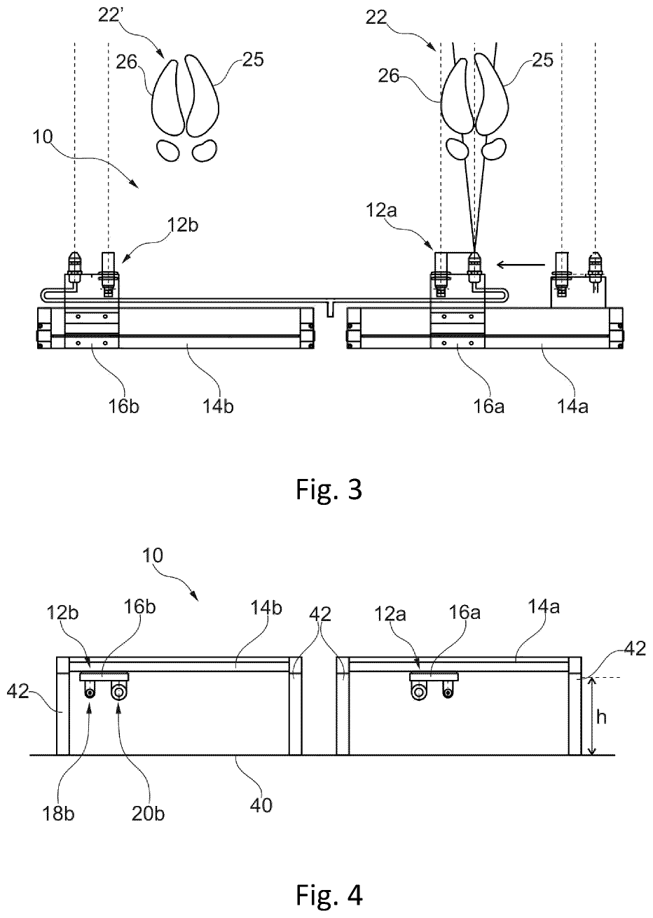

FIG. 3 shows a top view of a hoof spraying arrangement 10 according to a third embodiment of the present invention. The hoof spraying arrangement 10 of FIG. 3 is very similar to the hoof spraying arrangement as shown in FIG. 1 and differs in that the hoof spraying arrangement of FIG. 3 comprises per hoof a separate positioning arrangement 12 having a bracket 16 installed on a separate rail 14a, 14b to allow movement of the bracket 16a, 16b across the rail 14a, 14b by an individual drive unit 30. The rails 14a and 14b are positioned such that it is located behind one hoof alone and the positioning arrangement 12a and 12b will be moved behind only one hoof as to scan, detect and spray the one hoof.

Each bracket 16a and 16b is foreseen of an individual spraying device 18 and detector arrangement 20 such that each separate positioning arrangement 12a, 12b can work independent from the other positioning arrangement 12b,12a. Although not shown in the figures, the positioning arrangement 12a and/or 12b can be replaced by the positioning arrangement 12 as shown in FIG. 2, such that the detector arrangement would then contain two sensors 28a and 28b instead of only one sensor 28 per positioning arrangement 12a, 12b as shown in FIG. 3.

FIG. 4 illustrates a front view of the hoof spraying arrangement of FIG. 3 when installed in e.g. a dairy installation and fixedly mounted to the ground 40. As can be seen from this figure, the right position arrangement 12a has a bracket 16a on which the spraying device 18a is positioned on the right side of the bracket 16a, while the detector arrangement 20a having a sensor 28a is positioned on the left side of the bracket 16a. The spraying device 18b and detector arrangement 20b of the left arrangement 12b are mirror to the setup of the right position arrangement 12a, such that the spraying device 18b is again on the outside of the bracket 16b, while the detector arrangement 20b having a sensor 28b is positioned on the inside of the bracket 16b.

Both right arrangement 12a and left arrangement 12b of the hoof spraying arrangement 10 are placed a height h above the ground surface 40. The height h above the ground is chosen depending on the aimed position of the spraying devices 18a and 18b relative to the hoof of the animal in de hoof spraying arrangement 10. Typically, the height h is determined upon installation of the hoof spraying arrangement 10, but instead of using fixed rods 42 to install the hoof spraying arrangement, hydraulic cylinders (not shown) can be used instead of or in combination with the rods to provide for a flexible repositioning depending on the needs per animal entering the hoof spraying arrangement. Alternatively, an extendable rod could be used instead of fixed rod, such that a manual repositioning of the hoof spraying arrangement 10 can be done by changing the height of the extendable rod.

At the above described embodiments are illustrated having a single nozzle installed on the spraying device. Using a single nozzle allows for a compact construction. However, it has the disadvantage that typically only one spraying substance, being a liquid spray such as water, a combination of water and detergent, a disinfectant, or even a powder spray, can be used. When one wants to apply a secondary product such as disinfectant or a medicinal product, it is better to clean the hoof before applying this product. If not, a lot of the secondary product will be sprayed over the contaminated hoof without being able to reach the skin of the hoof and thus have a full effect.

This can be solved by a mixing unit (not shown) which will provide for a first product to be sprayed by the single nozzle of the spraying device during a specific time period, and subsequently provide for a second product to be sprayed by the same nozzle during a second specific time period. That way, the first product could be water or a water/detergent solution which will clean the hoof, while once clean, the second product such as a disinfectant can be sprayed onto the now clean hoof.

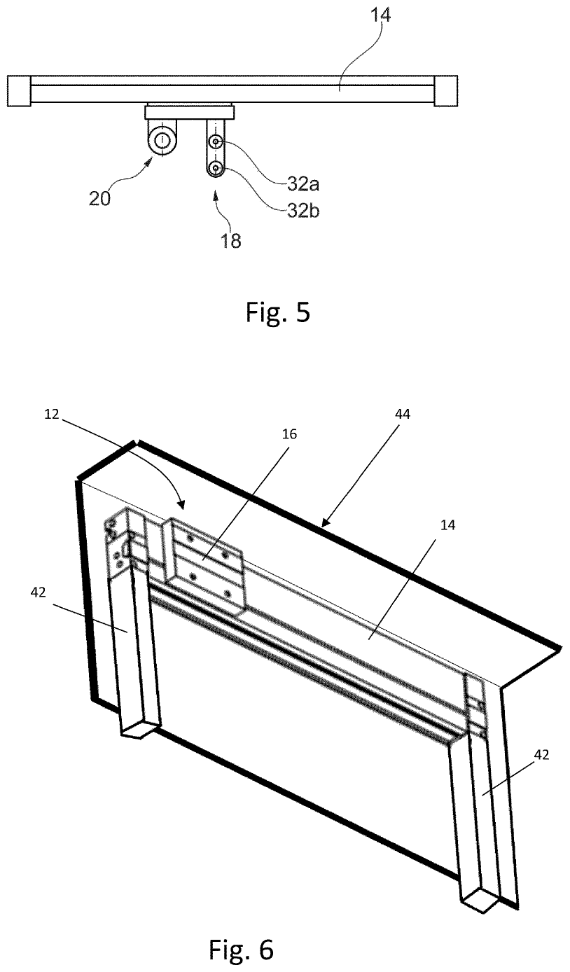

Another solution to use multiple products is shown in FIG. 5, where two nozzles 32a, 32b are placed on the bracket 16. Although both nozzles 32a, 32b may be directly mounted to the bracket 16, it is likewise possible to mount a first nozzle 32a to the bracket 16 and attaching the second nozzle 32b to the first nozzle 32b. The first nozzle 32a is thus placed above the second nozzle 32b. Typically, the first nozzle 32a will be used for the cleaning of the hoof and it is thus advantageous to have it installed above the second nozzle 32b such that the cleaning product will be sprayed higher compared to the second product when sprayed by the second nozzle 32b, which is thus positioned below the first nozzle 32a.

Optionally, the spraying range of the two nozzles 32a, 32b may be different from one another. Typically, the nozzle performing the cleaning function will have a wider spraying range than the nozzle applying the second spraying substance or product. In FIG. 5, the nozzle 32a spraying the first spraying substance will thus have a wider spraying range than the nozzle 32b which will spray the second spraying substance.

In FIG. 6, a 3D view of some elements of the hoof spraying arrangement is shown. As can be seen from FIG. 6, the rail 14 and positioning arrangement 12 are placed under a protective cover 44 to shield the hoof spraying arrangement from the environment and will protect the sensitive components such as the spraying device 18 and detector arrangement 20 from accidental stepping on them or of manure being deposited by the animal when being placed in the hoof spraying arrangement. Further, the stationary rods 42 are likewise shown which can be used to connect the hoof spraying arrangement with the ground 40.

As can be appreciated, it is possible to position the positioning arrangement 12 to the side of the rail 14 when the detecting, scanning and spraying of the hooves of the animal is done. That way, the sensitive components of the hoof spraying arrangement 10 are in a zone where it is unlikely that an animal will step on it and thus damage these components when maneuvering in and out the hoof spraying arrangement 10.

FIG. 7 illustrates a schematic overview of the control arrangement 100 which can be used with all embodiments of the present invention. As explained before, the sensor 28 will detect an outer contour 25, 26 of the hoof 2 2 of the animal in the hoof spraying arrangement 10. Depending on the software logic, a sensor signal 115 will be sent to a control unit 110.

When only one sensor 28 is used, or in case of two sensors 28a and 28b but only one being active, a continuous beam, such as ultrasound, will be emitted by the sensor. When the beam is reflected by the contour of the hoof of the animal, the sensor will send a sensor signal 115 to the control unit 110, when the sensor 28 no longer detects the presence of the hoof 22 the sensor signal is stopped. When the sensor signal 115 arrives at the control unit 110, the control unit 110 will immediately send a control signal 117 to the drive unit 30 to stop movement of the positioning arrangement 12. As soon as the positioning arrangement 12 has come to a stop, the control unit 110 will then send out a control spraying signal 119 to the spraying device 18 such that a first and potentially a second spraying substance can be applied. In some embodiments, the first spraying substance is sprayed on both hooves simultaneously, whereas the second spraying substance is sprayed on one hoof at the time.

When two sensors 28a, 28b are used, a first sensor signal 115a will be sent to the control unit 110 as soon as the sensor 28a detects the contour 25 of the hoof 22 of the animal by the movement of the positioning arrangement 12. As soon as the second sensor 28b also detects the same contour 25, a second sensor signal 115b will be sent to the control unit 110. When the control unit 110 received the second sensor signal 115b, the control unit 110 will immediately send a control signal 117 to the drive unit 30 to stop movement of the positioning arrangement 12. As soon as the positioning arrangement 12 has come to a stop, the control unit 110 will then send out a control spraying signal 119 to the spraying device 18 such that a first and potentially a second spraying substance can be applied. In some preferred embodiments, the first spraying substance is sprayed on both hooves simultaneously, whereas the second spraying substance is sprayed on one hoof at a time. In some embodiments, the first spraying substance is sprayed on both hooves simultaneously, and the second spraying substance is also on both hooves simultaneously.

Although not shown in the drawings, the above described hoof spraying arrangement 10 can be combined with a pressure plate which is well known in the art. Such a pressure plate is typically used to identify if an animal is not applying the same pressure on each hoof. This unequal distribution may be an indication that the hoof on which less pressure is applied is painful and hence the animal will not apply an equal pressure to it in an attempt to relieve the pain in this hoof. When this unequal distribution is detected, the control arrangement 100 can take this into account and e.g. only apply the first and second spraying substance to this identified hoof, while only applying a first spraying substance to the other hooves.

Alternatively, this information can be used to prolong the spraying time of the first and/or second spraying substance such that a sufficient amount of spraying substance is applied to this hoof.

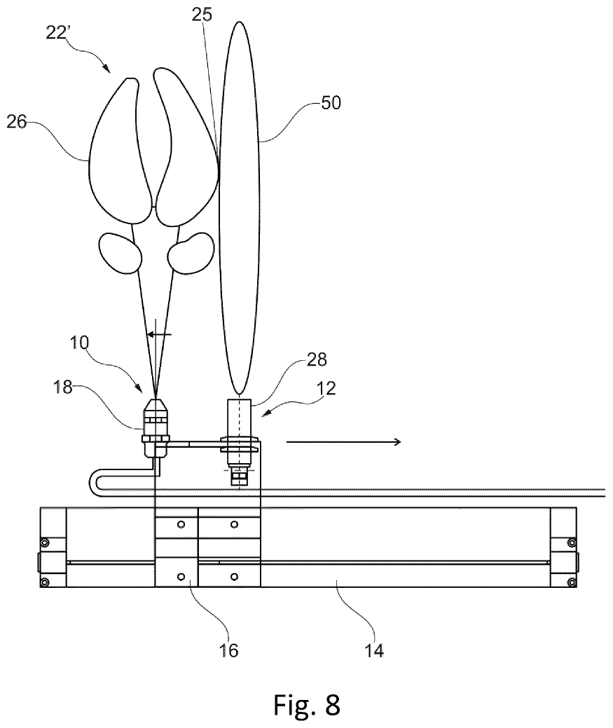

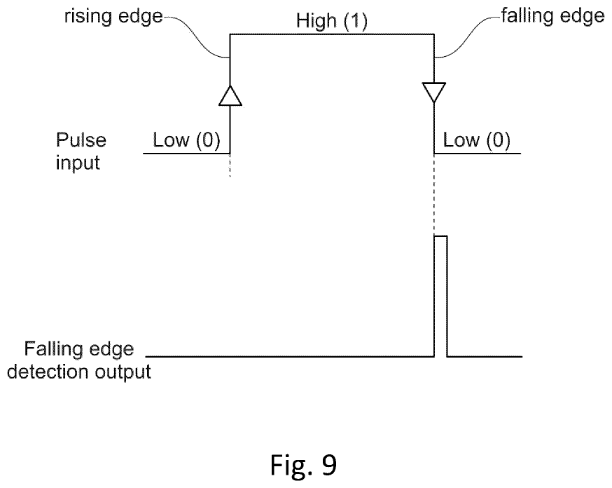

FIG. 8 shows a top view of a hoof spraying arrangement 10 according to an embodiment of the present invention. The hoof spraying arrangement comprises a positioning arrangement 12 having a bracket 16 installed on a rail 14 to allow movement of the bracket 16 across the rail 14 by a drive unit, e.g. a motor, (not shown). A spraying device 18 and a detector arrangement (configured to emit an ultrasonic beam and detect reflected waves) are mounted on the bracket 16 for simultaneous movement with the bracket 16 on the rail 14. The detector arrangement comprises at least one sensor 28 which by detecting the reflected waves, identifies the position of the hoof 22 of the animal in the hoof spraying arrangement 10. According to this embodiment, as the detection unit passes from left to right, the ultrasonic beam generates a reflected signal as the hoof is detected, which drops again, when the beam passes the hoof. The detector detects the falling edge of the reflected waves, which gives a signal to activate the spraying unit. The spraying unit is positioned such that it sprays on the desired position of the hoof when the signal is generated.

A similar combination can be made with the hoof spraying arrangement 10 and an infrared sensor, capable of detecting areas on the hoof which are warmer than other areas on the hoof. When specific areas of the hoof are warmer than other areas, this may indicate that an infection is present at this warmer area. If such a ‘hot zone’ is detected, a signal may be sent to the control arrangement 100 and the control unit 110 can then alter the time duration of the spraying time of the first and/or second spraying substance.

A further alternative combination can also be made where a scanning device is scanning the overall position of the animal in the hoof spraying arrangement 10. It is known that an animal in pain will typically have a different curvature of its back compared to the curvature of the back of a painless animal. Again, this information can be sent to the control arrangement 100 and the control unit 110 can use this information to amend the duration of the spraying of the first and/or second spraying substance.

The above described different embodiments can be used in a method for cleaning a hoof of animals in a hoof spraying arrangement. Therefore, the method comprises the steps of:
identifying the presence of an animal in the hoof spraying arrangement 10;
scanning the position of at least one hoof 22;
positioning the at least one spraying device 18 relative to the detected position of the at least one hoof 22;
spraying at least a first spraying substance 24 onto approximately the center point of the at least one hoof 22 and/or spraying a second spraying substance 24 onto approximately the center point of the at least one hoof 22.

The step of scanning the position of the at least one hoof 22 is accomplished by moving the positioning arrangement 12 such that the sensor 28 of the detector arrangement 20 detects and identifies the outer contour of the hoof.

The steps of scanning the position of the hoof 22 and positioning the at least one spraying device 18 may be done simultaneously.

Finally, the hoof spraying arrangement 10 of any of the described embodiments may be used to treat or prevent claw infection in animals.

1.-15. (canceled)

16. A hoof spraying arrangement arranged to spray a spraying substance onto one or more hooves of an animal, the hoof spraying arrangement comprising:
at least one spraying device for spraying at least one spraying substance onto the one or more hooves of an animal;
a control arrangement to control the spraying of the at least one spraying device;
at least one detector arrangement comprising at least one sensor; and
at least one positioning arrangement, the at least one spraying device being physically connected to the at least one positioning arrangement so as to guide the movement of the at least one spraying device,
wherein the at least one detector arrangement is physically connected to the at least one positioning arrangement such that the at least one spraying device and the at least one detector arrangement are moved simultaneously by the at least one positioning arrangement,
wherein the at least one detector arrangement is configured to determine the position of the at least one hoof of the animal in the hoof spraying arrangement and directs movement of the at least one positioning arrangement and the at least one spraying device to a desired position in relation to the detected position of the at least one hoof determined by the at least one detector arrangement.

17. The hoof spraying arrangement according to claim 16, wherein the at least one detector arrangement is positioned horizontally offset from the at least one spraying device on the at least one positioning arrangement.

18. The hoof spraying arrangement according to claim 17, wherein the detector arrangement is positioned between 2 and 10 cm horizontally offset from the position of the spraying device.

19. The hoof spraying arrangement according to claim 17, wherein the at least one spraying device is installed on one side of the positioning arrangement and the detector arrangement is installed on a second, opposite side of the positioning arrangement.

20. The hoof spraying arrangement according to claim 16, wherein the hoof spraying arrangement comprising a first positioning arrangement having a first detector arrangement and a first spraying device, and a second positioning arrangement having a second detector arrangement and a second spraying device.

21. The hoof spraying arrangement according to claim 20, wherein the first and second positioning arrangement are configured to position the first detector arrangement and the first spraying device, and respectively the second detector arrangement and the second spraying device simultaneously relative to the detected position of a first, and respective second hoof.

22. The hoof spraying arrangement according to claim 16, wherein the detector arrangement comprises two sensors, the first sensor being positioned on a first side of the positioning arrangement and the second sensor being positioned on a second, opposite side of the positioning arrangement, and wherein the spraying device is positioned in between the first and second sensors on the positioning arrangement.

23. The hoof spraying arrangement according to claim 16, wherein the at least one spraying device comprises at least two nozzles.

24. The hoof spraying arrangement according to claim 23, wherein the at least two nozzles are positioned vertically above one another.

25. The hoof spraying arrangement according to claim 23, wherein the spraying range of the first nozzle is wider than the spraying range of the second nozzle.

26. The hoof spraying arrangement according to claim 16, wherein the hoof spraying arrangement further comprises a rail or an extendable arm on which the at least one positioning arrangement is installed, and wherein the at least one positioning arrangement comprises:
a bracket for mounting the at least one spraying device and the detector arrangement on the at least one positioning arrangement, and
a drive unit to move the bracket on the rail or the extendable arm, as to position the bracket in relation to a hoof of an animal.

27. A method for the cleaning of a hoof of an animal in a hoof spraying arrangement according to claim 16, the method comprising the steps of:
optionally, identifying the presence of an animal in the hoof spraying arrangement;
determining the position of at least one hoof of the animal;
positioning the at least one spraying device relative to the detected position of the at least one hoof of the animal;
spraying at least a first spraying substance onto approximately the center point of the at least one hoof.

28. The method according to claim 27, wherein before spraying the second spraying substance onto approximately the center point of the at least one hoof, the method further comprises the step of scanning the position of the at least one hoof to redetermine the position of the at least one hoof.

29. The method according to claim 28, wherein the step of scanning the position of the at least one hoof comprises identifying an outer contour of the hoof of an animal.

30. The hoof spraying arrangement according to claim 17, wherein the detector arrangement is positioned between 4 and 8 cm horizontally offset from the position of the spraying device.

31. The hoof spraying arrangement according to claim 17, wherein the detector arrangement is positioned 6 cm horizontally offset from the position of the spraying device.

32. The method according to claim 27, further comprising spraying a second spraying substance onto approximately the center point of the at least one hoof.
